(19) United States
(12) Patent Application Publication
(10) Pub. No.: US 2018/0191082 A1
(43) Pub. Date: Jul. 5, 2018

(54) WIDEBAND ANTENNA ARRAY ON LAMINATED PRINTED CIRCUIT BOARD

(71) Applicant: Facebook, Inc., Menlo Park, CA (US)

(72) Inventor: Matthew Stoneback, Menlo Park, CA (US)

(21) Appl. No.: 15/394,720

(22) Filed: Dec. 29, 2016

(51) Int. Cl. H01Q 21/22; H01Q 1/52; H01Q 1/38; H01Q 1/22; H04B 7/06

(52) U.S. Cl. CPC H01Q 21/22; H01Q 1/526; H04B 7/0617; H01Q 1/2283; H01Q 1/38

(57) ABSTRACT

Systems and associated methods for improved phased array antennas are disclosed herein. In one embodiment, a communication system for wireless signals includes a printed circuit board (PCB), an M×N array of antenna elements carried by the PCB, and a radio chip carried by the PCB. In one disclosed embodiment the antenna elements can produce a gain of 29 dB over a bandwidth of 57-66 GHz.

### TECHNICAL FIELD

The present technology is generally related to the field of antennas and more specifically to the field of phased array antennas built on printed circuit boards (PCBs).

### BACKGROUND

An antenna (e.g., a dipole antenna) typically generates radiation in a pattern that has a preferred direction (i.e., the generated pattern is stronger in some directions and weaker in other directions). When receiving electromagnetic signals, the antenna has the same preferred direction (i.e., the received signal is strongest in the preferred direction). Therefore, signal quality (e.g., signal to noise ratio) can be improved by aligning the preferred direction of the antenna with a target receiver or a source of signal. However, it is often impractical to physically reorient the antenna with respect to the target, and/or the exact location of the target may not be known. To overcome some of the above shortcomings of the antenna, a phased array antenna can be formed from a set of antennas to simulate a large directional antenna. An advantage of the phased array antenna is its ability to transmit/receive signals in a preferred direction (i.e., its beamforming ability) without physically repositioning or reorienting the antenna. In operation, the individual antennas of the phased array antenna can receive their input signals from package pins of a radio chip.

FIG. 1 is a schematic illustration of a phased array antenna system 10 according to the prior art. The illustrated system has a phased array antenna 14 that includes four individual antennas 14i that are set apart by a half wavelength (λ/2) of the transmitted signal. A transmitter 12 generates signals for the phased array antenna 10. The transmitter 12 includes a modulator that receives two inputs (a baseband signal and a carrier oscillator) and outputs a modulated radio frequency (RF) signal. For example, a baseband signal having a relatively low frequency can be modulated by a carrier oscillator having a relatively high frequency to produce the modulated RF signal. The resulting modulated RF signal is transmitted through a beamformer 34 that adjusts amplitude and phase of the RF signal by applying an amplitude adjustment (ai) and a phase shift (θi) to the RF signal. A combination of the amplitude and phase adjustment for each individual antenna 14i is called a complex weight (wi) for that antenna. Since the resulting adjusted RF signal (i.e., adjusted by applying the complex weight) is generally a low power signal, power amplifiers 38i amplify the RF signals that leave the beamformer 34. Amplified RF signals arrive at the individual antennas 14i and are transmitted to surrounding space as a wireless signal.

In the illustrated example in FIG. 1, the wireless signal is transmitted in a direction D (i.e., a front F of the wireless signal makes an angle α (angle of antenna or AoA) with respect to the plane of the antennas 14i). The desired direction D of the wireless signal can be achieved by, for example, programming the beamformer 34 such that θ1>θ2>θ3>θ4 by appropriate Δθ, such that the front F makes angle α (AoA) with the plane of the antennas 14i. Analogously, if the phased array antenna 14 is a receiver and a source of an RF signal (i.e., a transmitter) is located in at AoA D, the distribution of θi's can be adjusted such that the phased array antenna has a maximum sensitivity in the direction D.

With some conventional systems, the package of a radio chip is designed to serve as an antenna. For example, the output pins of the chip package can be made large enough to function as individual antennas within a desired range of frequencies. With such a conventional system, the phase adjustment of the antenna signal at the adjacent pins of the chip package is relatively simple because of the direct connection between the circuits of the radio chip and the individual antennas that are the package pins. However, the individual antennas are typically relatively large, resulting in relatively large and expensive chip package pins.

With some other conventional systems, the radio chip is surface mounted to a PCB, and a phased array antenna is mounted on a daughter card that is connected to the PCB with a suitable connector (e.g., an edge connector). In operation, the signals from the radio chip are routed through the PCB and further to the phased array antenna on the daughter card. However, such a conventional system is also typically large and mechanically fragile. Furthermore, the connectors between the PCB and the daughter card add electrical resistance and, if the impedances are not properly matched, the connectors may cause reflected waves. Accordingly, it would be advantageous to provide a compact and robust system incorporating a phased array antenna and one or more radio chips on the same PCB.

### BRIEF DESCRIPTION OF THE DRAWINGS

FIG. 1 illustrates a conventional phased array antenna.

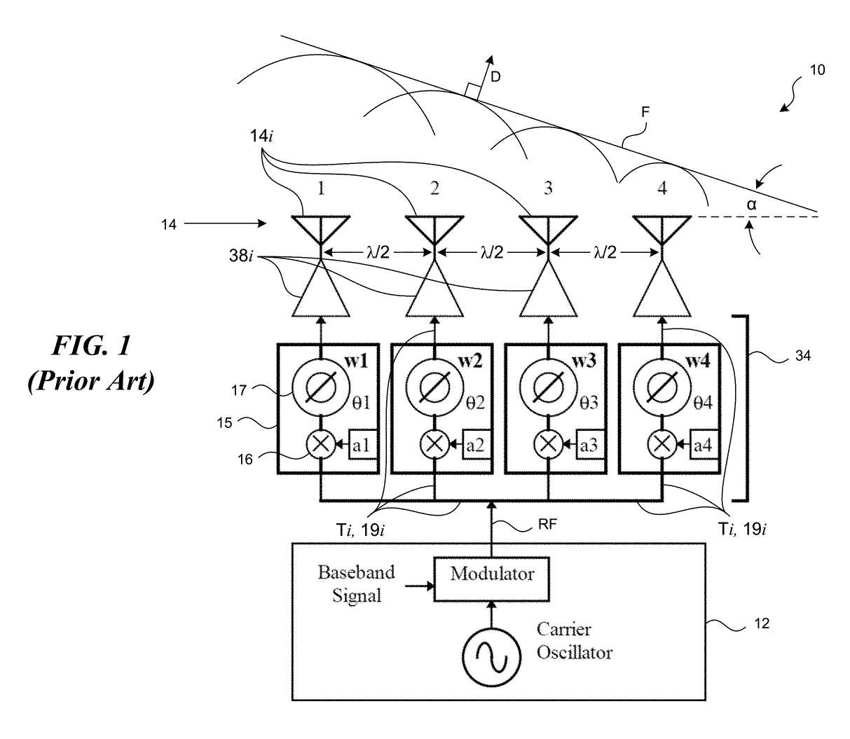

FIG. 2A is a schematic view of a phased array antenna in accordance with an embodiment of the present technology.

FIG. 2B is a schematic view of an antenna element in accordance with an embodiment of the present technology.

FIG. 3 illustrates a number of layers in a laminated PCB in accordance with one embodiment of the present technology.

FIG. 4 is an isometric view of a number of patch antennas, signal traces and shielding vias within a laminated PCB that is constructed in accordance with an embodiment of the present technology.

FIG. 5 illustrates a radio frequency transceiver chip and a number of traces that connect pins on the radio transceiver chip to antenna elements formed in a PCB in accordance with embodiments of the present technology.

FIGS. 6A and 6B illustrate traces that route a signal from the radio frequency chip to a number of parallel connected antenna elements in a column of a matrix antenna in accordance with an embodiment of the present technology.

FIG. 7A is a graph of a signal return loss in dB for the phased array antenna in accordance with an embodiment of the present technology.

FIG. 7B is a graph of a peak realized gain in dB for the phased array antenna in accordance with an embodiment of the present technology.

### DETAILED DESCRIPTION

The following disclosure describes various embodiments of systems and associated methods for incorporating a high frequency M×N matrix phased array antenna on a PCB. Most phased array antennas require precisely controlled differences between the positions of the individual antennas (also termed “antenna elements”) produce a desired directivity (i.e., angle of antenna or AoA) of a wireless signal. Having such an antenna incorporated into a PCB to which other circuits can be mounted can decrease the size of radio frequency equipment and can reduce cost.

In some embodiments of the present technology, a packaged radio chip is mounted on a surface of a laminated PCB. In one embodiment, a set of individual antenna elements of a phased array antenna are incorporated into the PCB and connected with signal traces to the individual output pins of the radio chip package. Multiple phase antenna elements can be laid out on the same PCB and connected to the radio chip. In some embodiments, a phased array antenna can include an M×N matrix of antenna elements having multiple rows and columns of antenna elements on the PCB. An output pin of the radio chip may be connected to multiple parallely connected antenna elements in a single column of the antenna on the PCB. Another output pin may be connected to an adjacent column of antenna elements and so forth. In operation, the pins of the radio chip produce output signals with suitable phase offsets to drive a radio signal at a desired angle (e.g., an AoA). In some embodiments, the traces that connect an output pin of a radio chip to individual antenna elements of the phased array antenna have an equal electrical length to reduce the likelihood that the traces will contribute to an undesired phase delay in the signals arriving at different columns of antenna elements.

In some embodiments, the PCB can be made of layers of a material that has a relatively low loss tangent and a low dielectric constant to reduce the parasitic losses of the phased antenna array. In some embodiments, the conductive traces and signal vias found within the PCB are surrounded by a fence of noise suppression micro-vias to reduce cross-talk between the adjacent signal-carrying traces/signal vias. In some embodiments, the individual antenna elements are patch antennas with a single driven element and may include one or more additional passive elements positioned in line with the driven element to increase bandwidth. In one embodiment, these passive elements are formed from copper areas in layers of the laminated PCB.

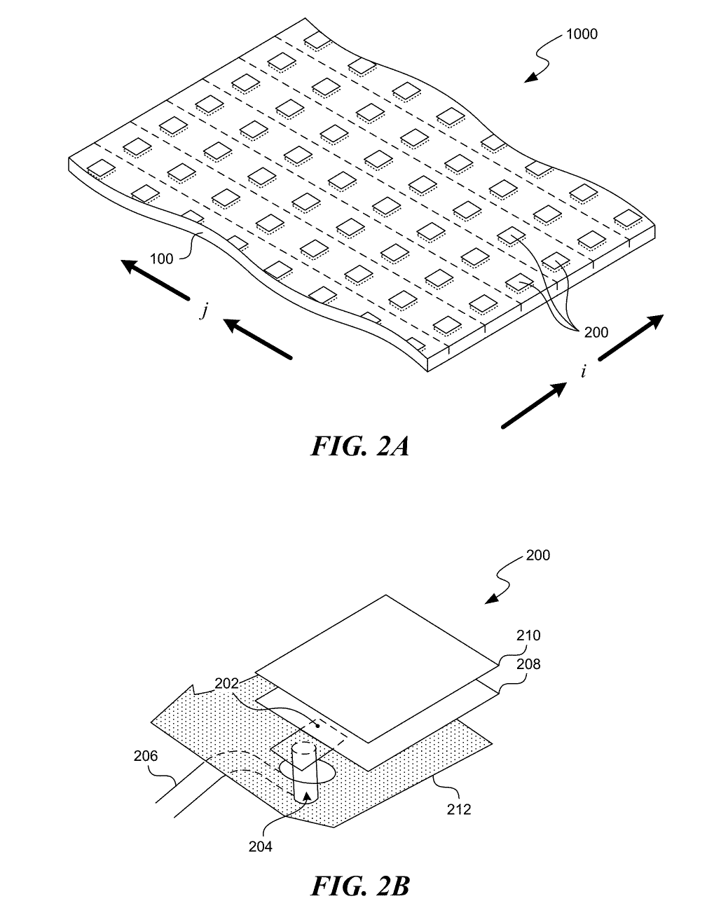

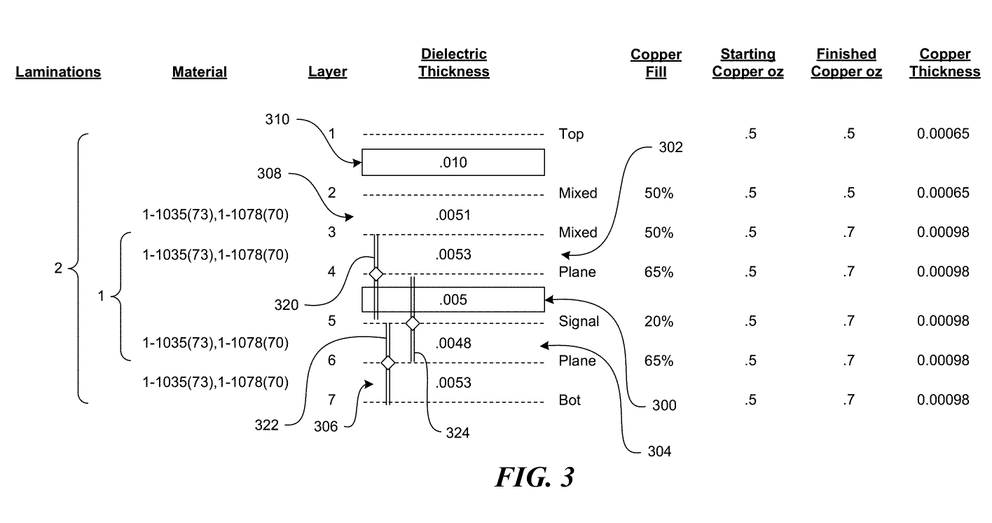

FIG. 2A is an isometric view of a top layer of a laminated PCB 100 including an M×N array 1000 of antenna elements in accordance with an embodiment of the present technology. The illustrated phased array antenna 1000 includes a number of individual antenna elements 200 distributed in rows i and columns j. In one embodiment, the antenna array includes an 8×32 matrix of active antenna elements with each 8 element column being driven in common by a pin on a radio frequency chip (not shown). In some embodiments, the array may include one or more columns of inactive antenna elements on either end of the active elements to prevent the end columns from seeing a different impedance than columns that are surrounded by active columns.

In operation, the antenna elements 200 of a given column emit electromagnetic waves that are generally in phase, while the antenna elements of the adjacent column may emit signals with a different phase, and so forth to achieve a desired angle of the electromagnetic wave (e.g., an AoA) leaving the PCB 100. In some embodiments, the phased array antenna 1000 may be used in intra-city wireless networks because of its relatively small size, low cost and energy efficiency.

FIG. 2B illustrates one embodiment of an individual patch antenna formed on the PCB. Each antenna element 200 comprises a driven element 202 that is fed with a signal via 204 from inside the PCB. The other end of the signal via is connected to a signal trace 206 that is contained on an internal layer of the PCB. Above the driven element 202 are a pair of passive elements 208 and 210 that are located on different layers of the PCB. In one embodiment, a shielding layer 212 is positioned in a layer between the layer of the PCB that carries a signal trace 206 and the layer that carries the driven element 202. In some embodiments, the upper passive element 210 can be laid out in the outmost layer of the PCB, and the lower passive element 208 can be laid out in the next adjacent layer of the PCB. Although the active and passive elements 202, 208 and 210 are rectangular in the illustrated embodiment, the antenna elements may have other shapes such as round, square, elliptical etc. In some embodiments, the driven and passive antenna elements are made of copper foil.

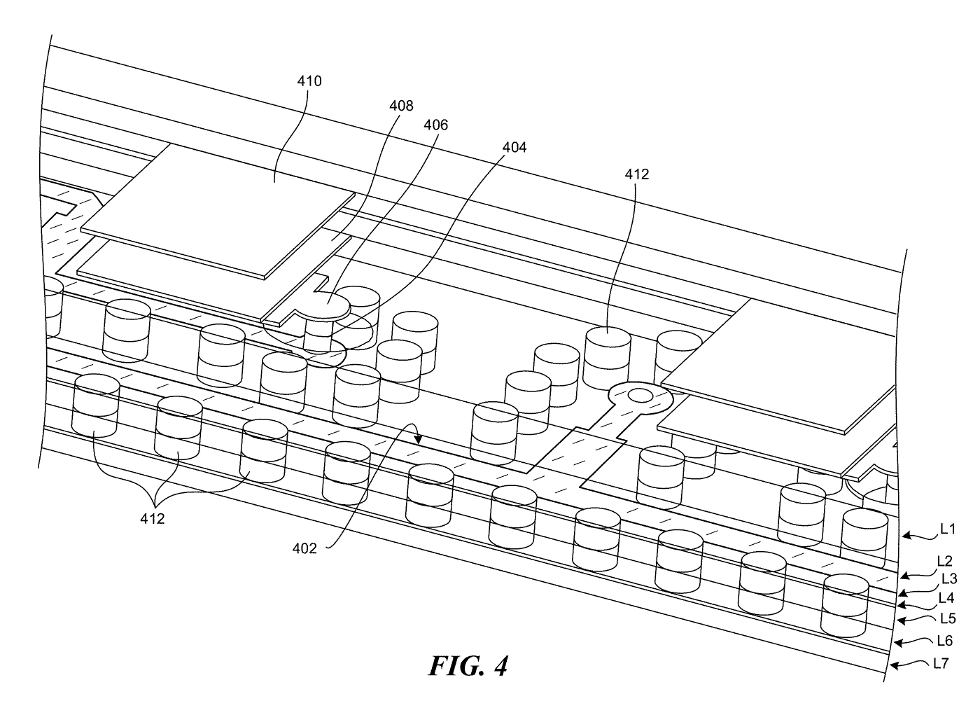

FIG. 3 is a cross-sectional view of the layers of a laminated PCB in accordance with an embodiment of the present technology. In the embodiment shown, the PCB includes seven laminated layers. The PCB is constructed from a center core section 300 having a top surface that forms layer 4 and a bottom surface that forms layer 5 of the PCB. In one embodiment, the core 300 is 0.005″ thick and is copper clad on both sides. Laminated to the upper surface of the core 300 is a layer 302, the top surface of which forms layer 3 of the PCB. Similarly, a laminate layer 304 is adhered to the bottom of the core 300. The bottom surface of the laminate layer 304 forms layer 6 of the PCB. The bottom of the PCB is formed from a laminate layer 306 that is adhered to layer 6. A laminate layer 308 is adhered to layer 3 of the PCB. The top surface of layer 308 forms layer 2 of the PCB. Finally, a top core layer 301 is adhered to the top surface of layer 2 and forms layer 1 of the PCB.

In one embodiment, the laminate layers are formed from cloth styles 1035 or 1078 that is impregnated with a resin having a low dielectric and a loss tangent. Suitable resin materials could include Isola Astra MT™ or Panasonic Megtron™. However, other low loss resin materials may be suitable. In one embodiment, the dielectric is chosen to be less than 4 and more preferably less than 3.5 and most preferably 3.0 or less. Similarly, the loss tangent is preferably less than 0.003 and more preferably 0.002 or less. In some embodiments, the PCB can include seven conductive layers (e.g., copper metallization layers) having a thickness of 0.00065″ or 0.00098″ (i.e., 0.5 ounce or 0.7 ounce copper metallization). In some embodiments, traces in the layers of the PCB can be electrically interconnected with signal vias 320 to establish appropriate routing of signals between the different layers of the PCB. Signal vias 322 extend from the bottom surface of the PCB to the signal traces on layer 5 of the PCB. Finally, a number of shielding micro-vias extend between the shield layers 4 and 6 at positions around the signal traces in a single layer of the PCB and the signal vias that extend between layers of the PCB to prevent crosstalk between antenna elements and between adjacent antenna columns.

In one embodiment, the various layers of the PCB have thicknesses that are non-symmetric with respect to the inner core that forms layer 3 and layer 4.

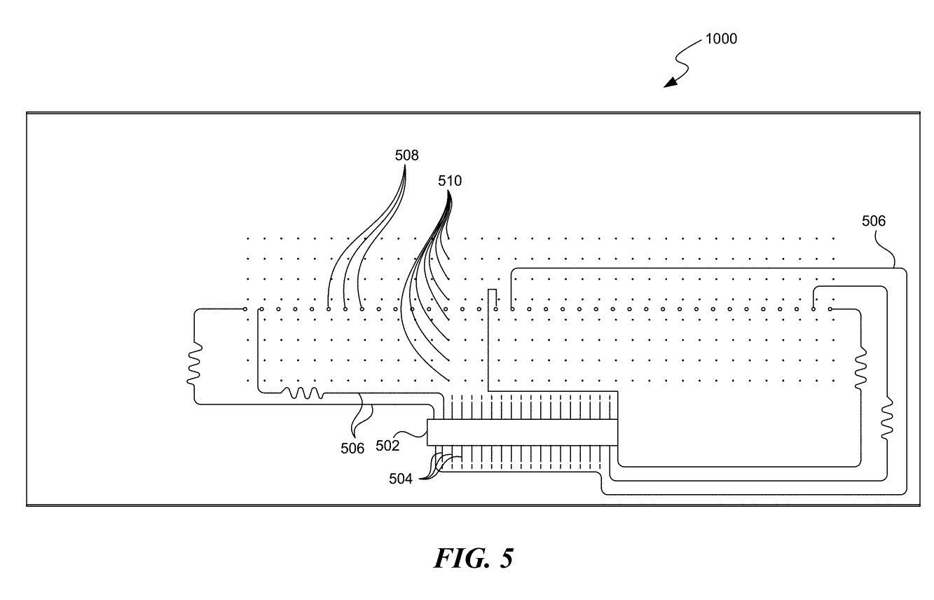

FIG. 4 illustrates a portion of a column of antenna elements in the PCB. On layer 5 of the PCB is a pattern of signal traces 402 that provide signals to each antenna element in the column. The signal traces 402 preferably have a “corporate tree” structure like a binary tree where the distance from the center point where the trace is fed to the ends of the leaves that connect to the antenna elements are the same. Signal vias 404 extend from the signal traces 402 on layer 5 to the driven antenna elements 406 of layer 3 of the PCB. Above the driven element 406 are a pair of passive elements 408 (on layer 2) and 410 (on the top of layer 1). In one embodiment, the passive elements are approximately 2 mm. long on each side. However the size may vary depending on the desired frequency range at which the antenna is to operate.

Surrounding the signal traces 402 and the signal vias 404 is a picket fence of shielding micro-vias 412 that connect the shielding layer 3 to shielding layer 6 that enclose the signal layer 5. In one embodiment, the vias and micro-vias are copper-filled holes having a diameter of 0.008 inches. In one embodiment, the vias are laser drilled and filled as the laminated layers of the PCB are built up so that the conducting copper solution for the vias will fill the holes properly.

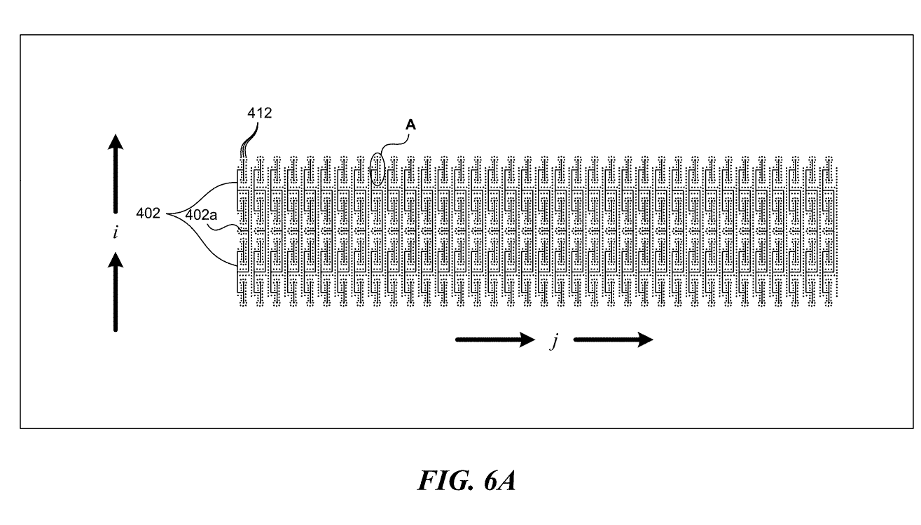

FIG. 5 illustrates a bottom surface of the PCB 1000 that includes a radio frequency transceiver chip 502 secured to the PCB. The radio frequency transceiver chip 502 includes a number of pins 504 that provide RF signals for transmitting to and for receiving RF signals from the antenna elements. The pins 504 are connected to the columns of antenna elements via signal traces 506. In one embodiment, the signal traces 506 that extend from the pins of the transceiver chip 502 to a number of signal vias 508 that route the signals all have the same electrical length. In this way, any phase differences in the signals transmitted by the columns of antenna elements are due to the phase differences produced by the radio frequency transceiver chip 502 and not due to mismatches in the electrical characteristics of the different signal feed lines. In the embodiment shown, the signal vias 508 that feed the columns of antenna elements are located in the center of each column to simplify the routing of the traces to each individual antenna element.

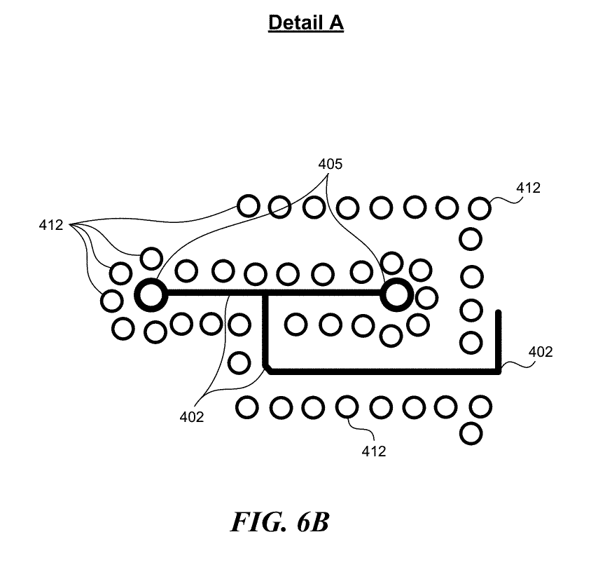

FIG. 6A shows a further view of the signal routing traces 402 that are included in layer 5 of the PCB. As discussed above, the signal traces 402 have a corporate tree structure so that signals applied in a middle 402a of the trace follow a path that is the same length to each end of the leaves where they are connected to driven element of the antenna. Also shown in FIG. 6A are the fences of shielding micro-vias 412 that surround the signal traces and the signal vias that carry the signals to other layers of the PCB.

FIG. 6B shows additional detail of a portion of the fence of shielding micro-vias 412 that surround the signal traces 402 in the PCB. The micro-vias 412 connect the shielding layer 4 to the shielding layer 6 on either side of layer 5 and are positioned around the length of the traces 402 and around the signal vias that carry the signals from the traces 402 to the driven antenna elements on layer 3 of the PCB.

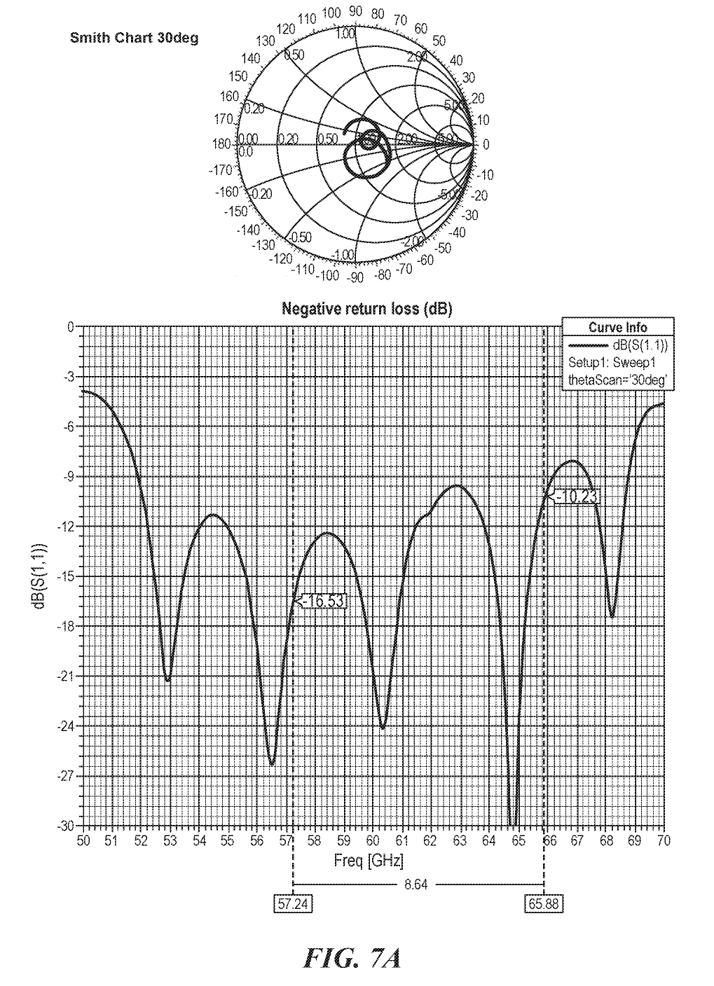

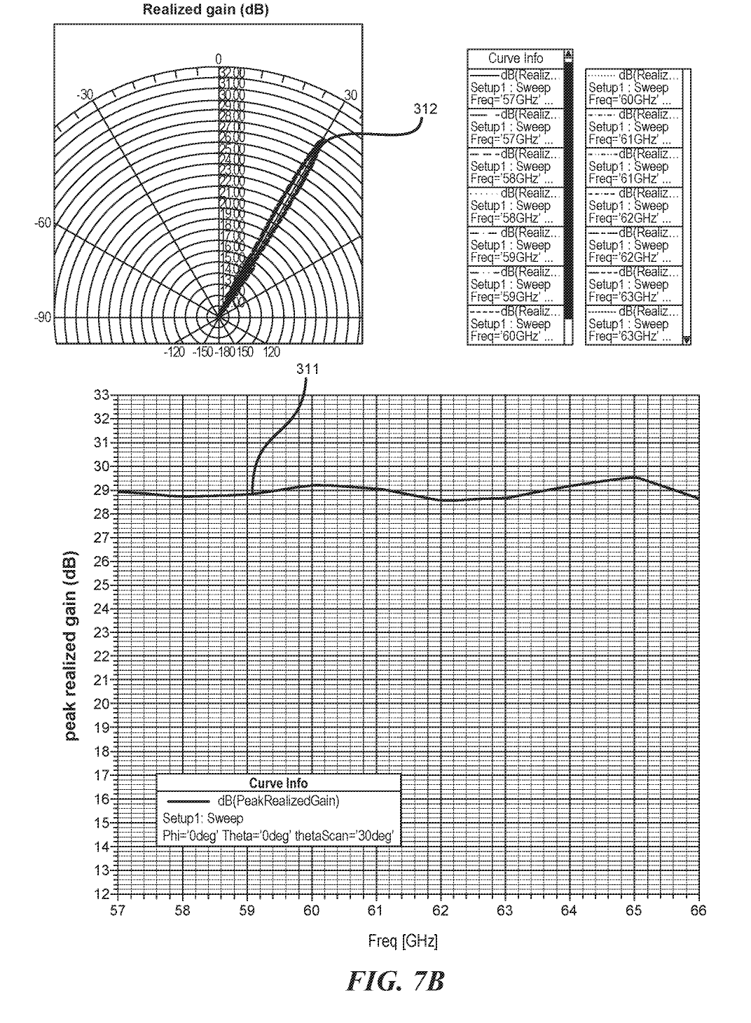

FIGS. 7A and 7B illustrate test results obtained with an embodiment of the antenna array 1000. FIG. 7A is a graph of a signal return loss for the phased array antenna in accordance with an embodiment of the present technology. The horizontal axis of the graph represents a frequency of signal in GHz, and the vertical axis represents the signal return loss in dB (e.g., the input port voltage reflection coefficient S₁₁ in dB). The test results were obtained for the phased array angle of 0° (e.g., the columns of the antenna elements receiving an in-phase signal from the radio chip). With the illustrated embodiment, the signal return loss remains below −9 dB for the frequencies of interest. For some frequencies, the return loss falls below −24 dB. In at least some embodiments, the signal return loss that is below −9 dB can be considered as relatively low return loss. In the disclosed embodiment, the bandwidth of the antenna array extends from approximately 57-66 GHz.

FIG. 7B is a graph of a signal gain for the phased array antenna in accordance with an embodiment of the present technology. The horizontal axis of the graph represents a frequency of signal in GHz, and the vertical axis represents the peak realized gain in dB (e.g., the forward voltage gain coefficient S₂₁ in dB). The test results were obtained for the phased array emitting at an angle of 30° (e.g., the signals from the radio transceiver circuit reaching the individual columns of the antenna elements 201j/202j at phase delays that result in a 30° AoA of the emitted beam). For the frequency range of 57-66 GHz, the peak realized gain remains above about 28 dB, which, for at least some embodiments, may be considered as a relatively high gain.

From the foregoing, it will be appreciated that specific embodiments of the invention have been described herein for purposes of illustration but that various modifications may be made without deviating from the scope of the various embodiments of the invention. For example, multiple radio chips may be attached to a single PCB. Similarly, the PCB may include more than one antenna array. Furthermore, while various advantages and features associated with certain embodiments of the disclosure have been described above in the context of those embodiments, other embodiments may also exhibit such advantages and/or features, and not all embodiments need necessarily exhibit such advantages and/or features to fall within the scope of the disclosure. Accordingly, the disclosure is not limited, except as by the appended claims.

1. A communication system for wireless signals, comprising:
a printed circuit board (PCB);
a phased array of individual antenna elements carried by the PCB, wherein the phased array is a matrix of the individual antenna elements disposed on a side of the PCB and each column of the matrix is connected to a respective output pin of a radio chip to produce output signals; and
the radio chip carried by the PCB.

2. The system of claim 1, wherein the side of the PCB is a first side and the PCB has a second side opposite the first side, wherein the radio chip is disposed on the first side, and wherein the phased array of individual antenna elements is on the second side.

3. The system of claim 1, wherein the PCB includes a plurality of dielectric layers and a plurality of conductive layers, and wherein the dielectric layers are made at least in part from a low dielectric loss and a low loss tangent material.

4. The system of claim 1, wherein the PCB comprises a plurality of layers having non-symmetric thicknesses.

5. The system of claim 1, wherein each individual antenna element include:
a driven element; and
one or more passive antenna elements in line with the driven element.

6. The system of claim 1, wherein the PCB includes a signal trace layer that is surrounded on either side by shielding layers, and wherein signal traces in the signal trace layer are surrounded by a fence of shielding micro-vias that are electrically connected to the shielding layers.

7. The system of claim 6, wherein the PCB includes signal vias that carry signals between different layers of the PCB and the shielding micro-vias are positioned around the signal vias.

8. (canceled)

9. The system of claim 1, wherein the PCB includes traces that route radio signals from the radio chip to the individual antenna elements, wherein the traces are configured as a corporate tree having a number of branches of equal electrical length.

10. The system of claim 1, wherein each column of the matrix has 8 individual antenna elements.

11. The system of claim 1, wherein the phased array of individual antenna elements has 32 columns of active antenna elements.

12. The system of claim 3, wherein the layers have a dielectric constant that is less than 3.5.

13. The system of claim 12, wherein the layers have a dielectric constant that is less than 3.0.

14. The system of claim 3, wherein the layers have a loss tangent that is 0.002 or less.

15. The system of claim 3, wherein the phased array of individual antenna elements has a bandwidth of 57-66 GHz.

16. A method for producing a phased array antenna, the method comprising:
patterning a layer of signal traces on one side of a copper clad core for a printed circuit board (PCB);
placing a top and bottom shielding layer on either side of the layer of signal traces;
placing a layer of driven elements over the top shielding layer;
connecting the driven elements to the signal traces with signal vias;
placing shielding vias around the signal traces where the shielding vias electrically connect the top and the bottom shielding layer on either side of the layer of signal traces;
placing a bottom layer of signal routing traces under the bottom shielding layer;
connecting the bottom layer of signal routing traces to the layer of signal traces that is between the shielding layers with the signal vias; and
securing a radio frequency chip to the bottom layer of the PCB and connecting pins of the radio frequency chip to the signal traces on the bottom layer of signal routing traces, wherein the signal traces are connected to a phased array that is a matrix of individual antenna elements and each column of the matrix is connected to a respective output pin of the radio frequency chip to produce output signals.

17. The method of claim 16, further comprising placing one or more layers of passive antenna elements over the layer of driven elements.

18. A method for beamforming, comprising:
sending radio frequency signals from a radio chip to a phased array antenna that is a matrix of individual antenna elements, wherein each column of the matrix is connected to a respective output pin of the radio chip to produce output signals, wherein the radio chip is carried on a first side of a PCB, and wherein the phased array antenna is incorporated into a second side of the PCB opposite from the first side of the PCB; and
beamforming a wireless signal from the antenna elements of the phased array antenna.

19. The method of claim 18, wherein the radio frequency signals have a frequency in a range of 57-66 GHz.
